(19) United States
(12) Patent Application Publication
(10) Pub. No.: US 2002/0198848 A1
(43) Pub. Date: Dec. 26, 2002

(54) Transaction verification system and method

(76) Inventor: John R. Michener, Salinas, CA (US)

Correspondence Address: DINNIN & DUNN, P.C., TOP OF TROY BUILDING, 755 WEST BIG BEAVER ROAD, TROY, MI, 48084, US

(21) Appl. No.: 10/185,849

(22) Filed: Jun. 26, 2002

Related U.S. Application Data
(60) Provisional application No. 60/301,067, filed on Jun. 26, 2001.

(51) Int. Cl. G06F 17/60

(52) U.S. Cl. 705/75; 713/168

(57) ABSTRACT

A user enters into a token a token PIN, and an identification number of a financial instrument and a transaction amount of a transaction to be verified. If the token PIN is correct, a processor in the token increments a transaction count, and generates a first passcode using an encryption process using a digest keyset to digest the information entered into the token. The user provides the first passcode, the transaction count, and an identification number associated with the token to a merchant, who then transmits this to a financial institution, along with the identification number of the financial instrument and the transaction amount. The financial institution transmits this information to a verification server, which uses the digest keyset associated with the token to generate a second passcode by digesting the same quantities as used to generate the first passcode. The verification server verifies the transaction responsive to whether the first and second passcodes are equal, and to whether the transaction count is greater than the last transaction count associated with the token.

The instant application claims the benefit of U.S. provisional application No. 60/301,067 filed on Jun. 26, 2001, which is incorporated herein by reference.

In the accompanying drawings:

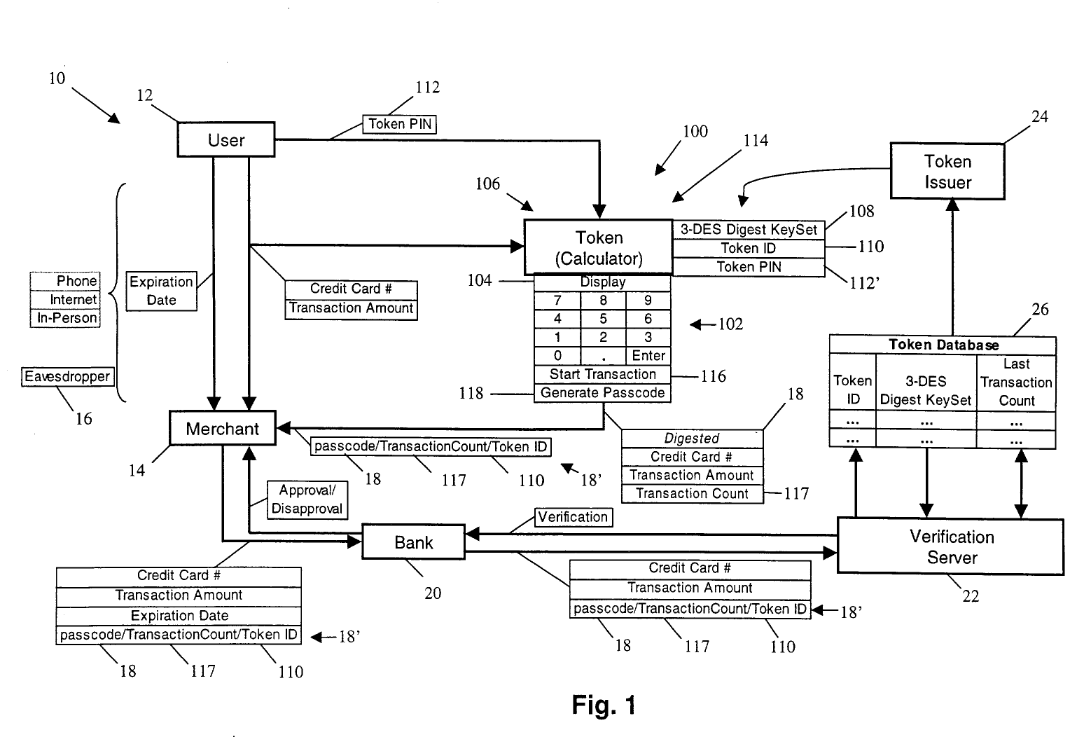

FIG. 1 illustrates a first embodiment of a transaction verification system;

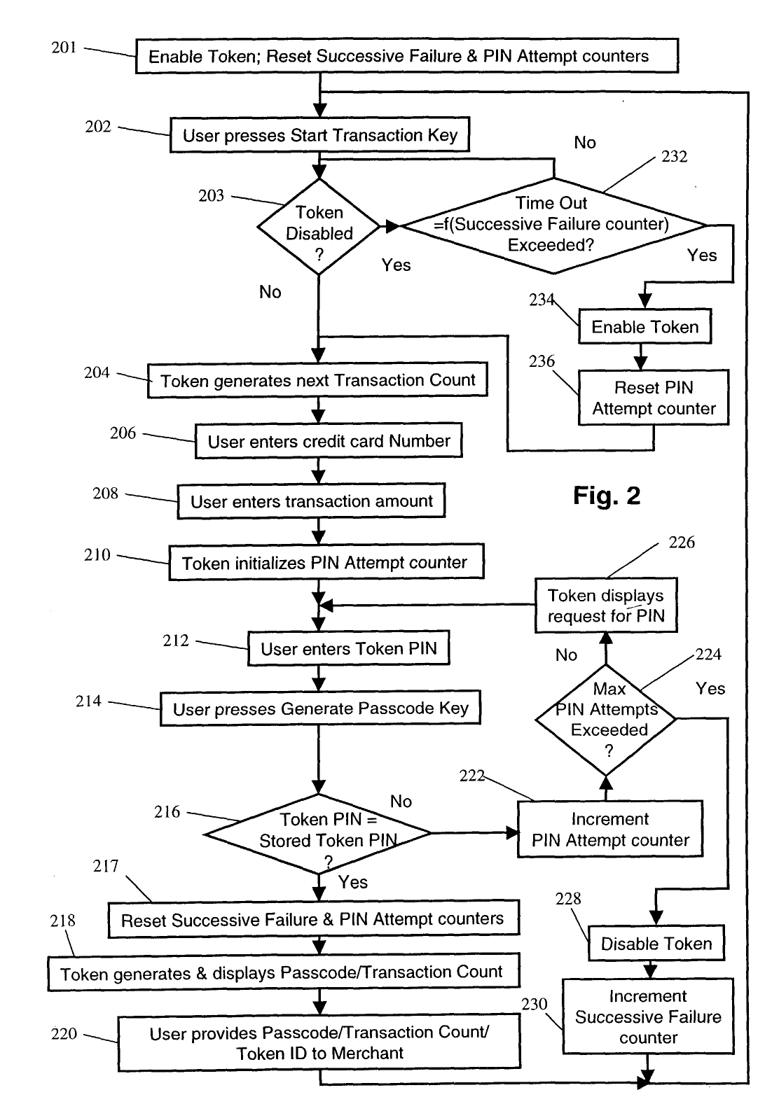

FIG. 2 illustrates a first embodiment of a process for generating a passcode used to verify a transaction;

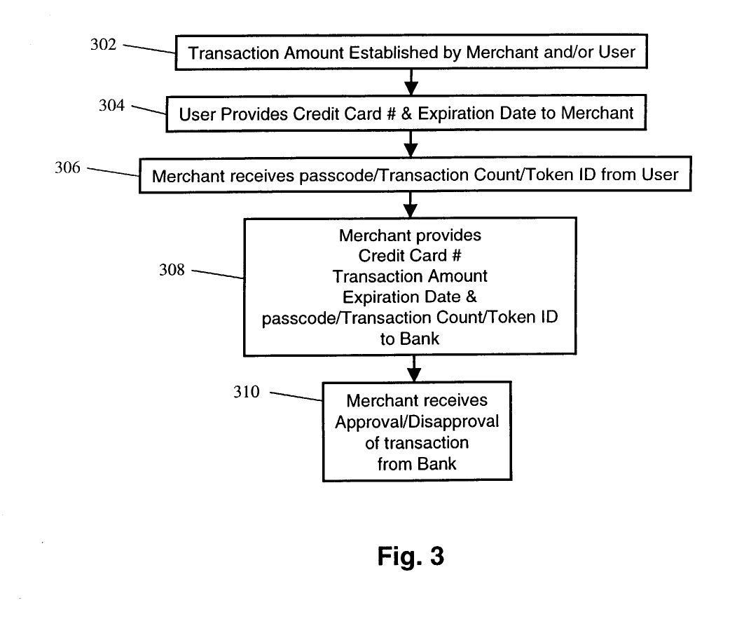

FIG. 3 illustrates a first embodiment of a process by which a merchant verifies a transaction;

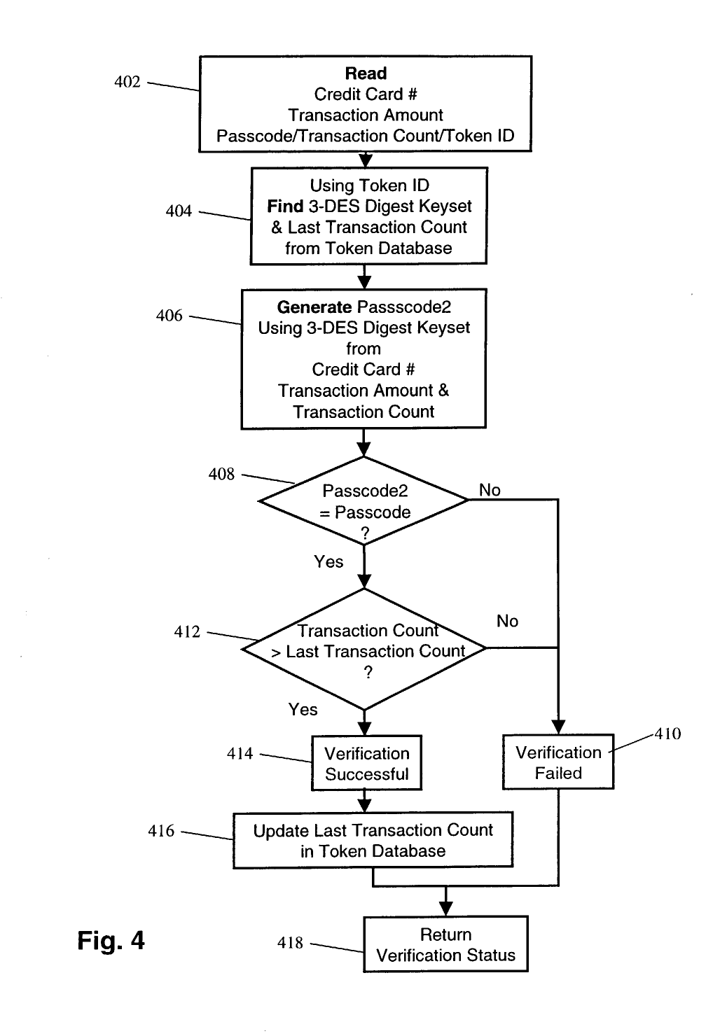

FIG. 4 illustrates a first embodiment of a process for verifying a transaction using a passcode.

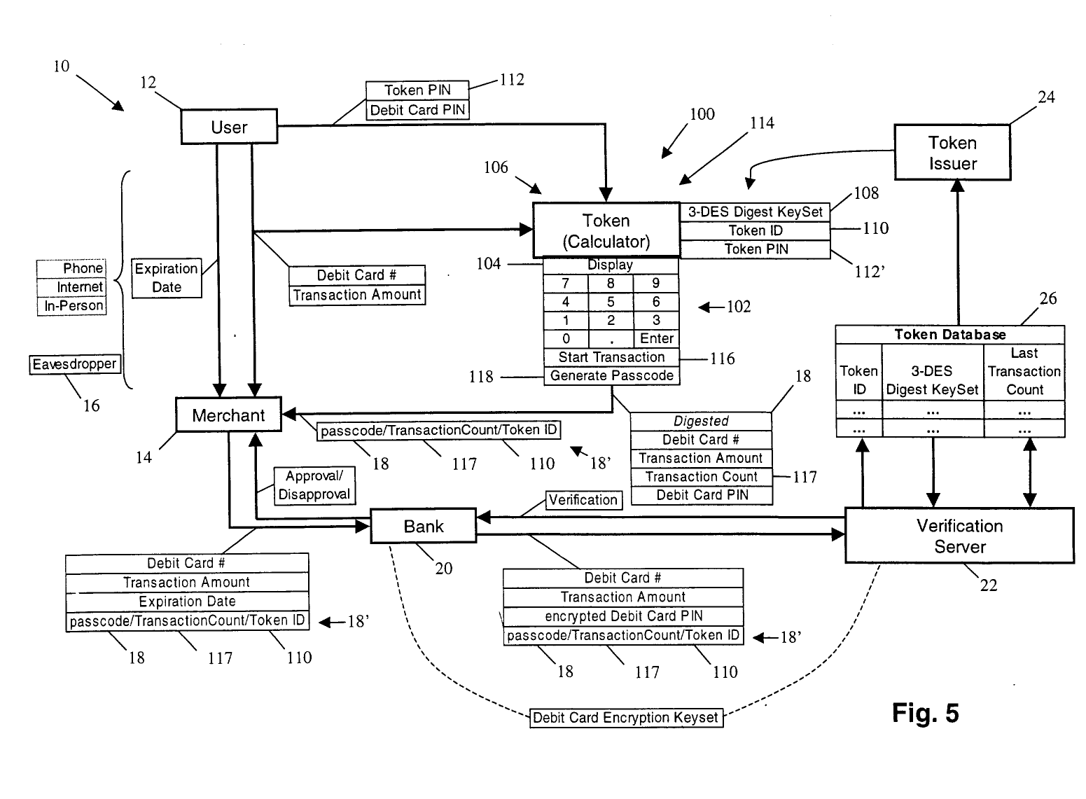

FIG. 5 illustrates a second embodiment of a transaction verification system;

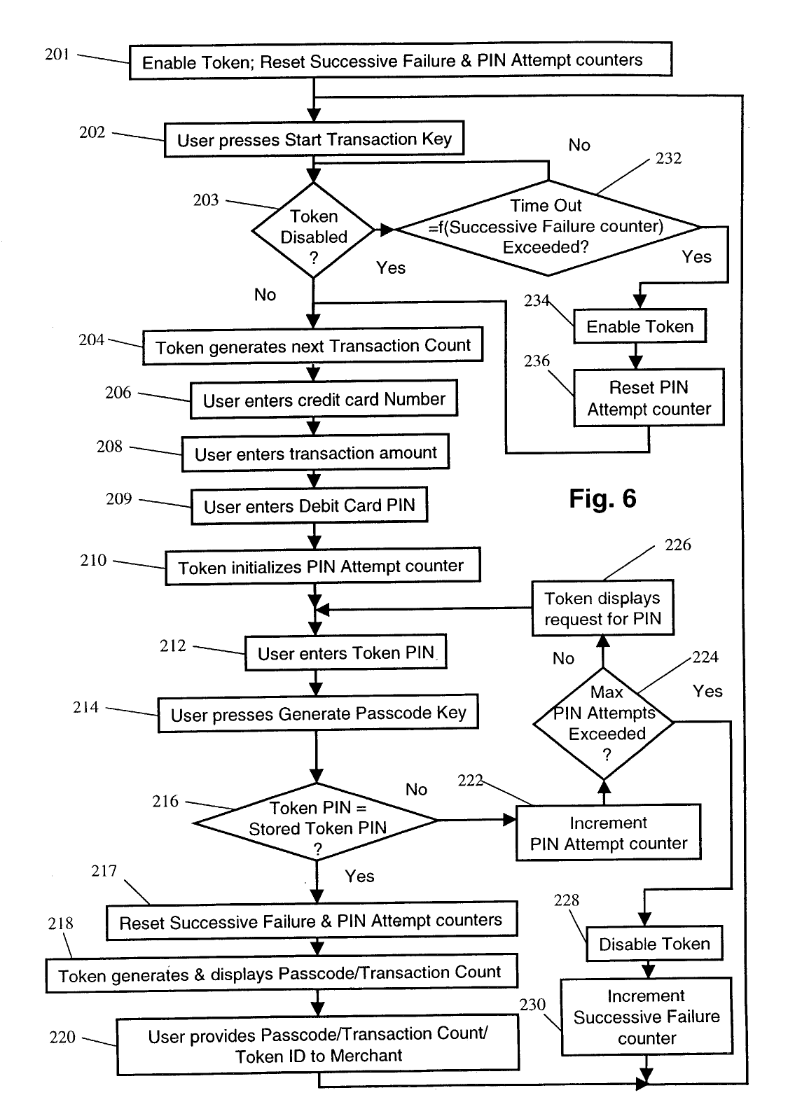

FIG. 6 illustrates a second embodiment of a process for generating a passcode used to verify a transaction;

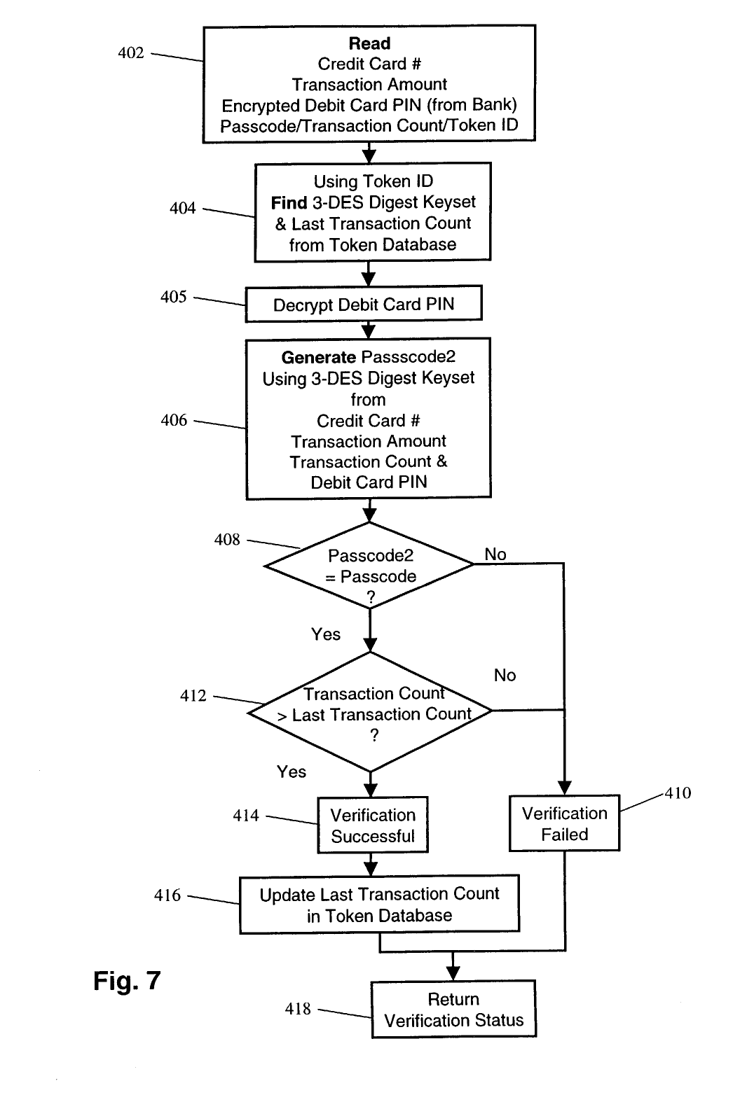

FIG. 7 illustrates a second embodiment of a process for verifying a transaction using a passcode.

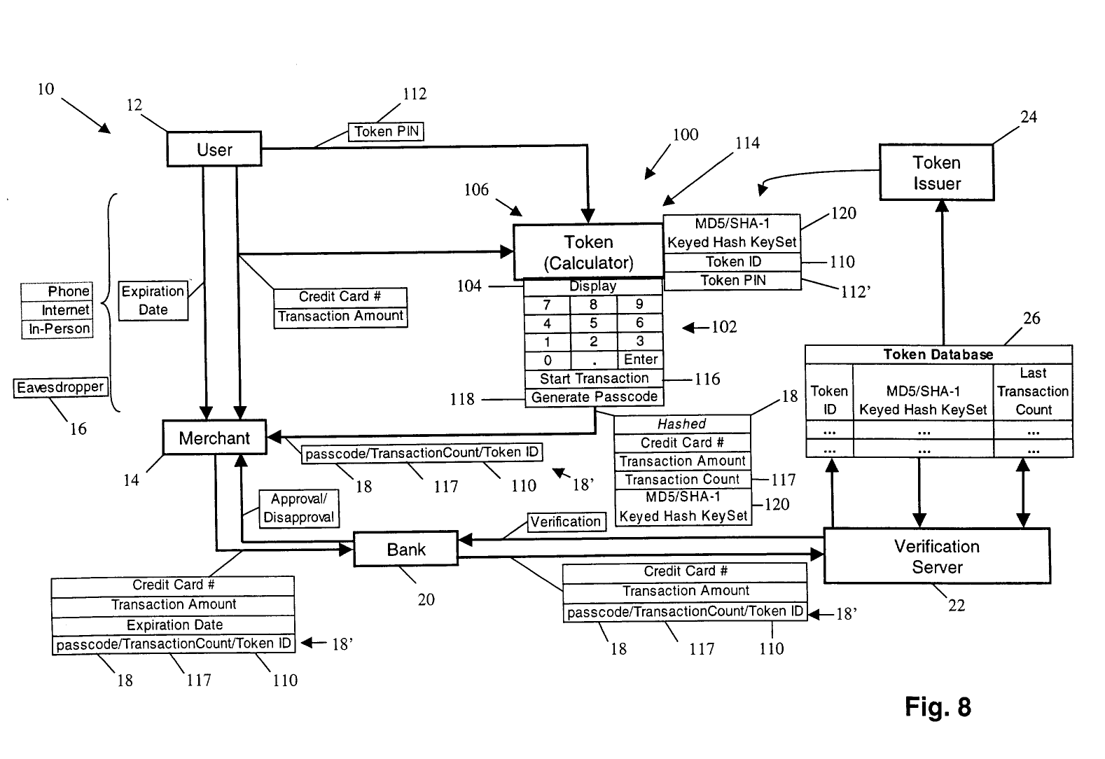

FIG. 8 illustrates a third embodiment of a transaction verification system;

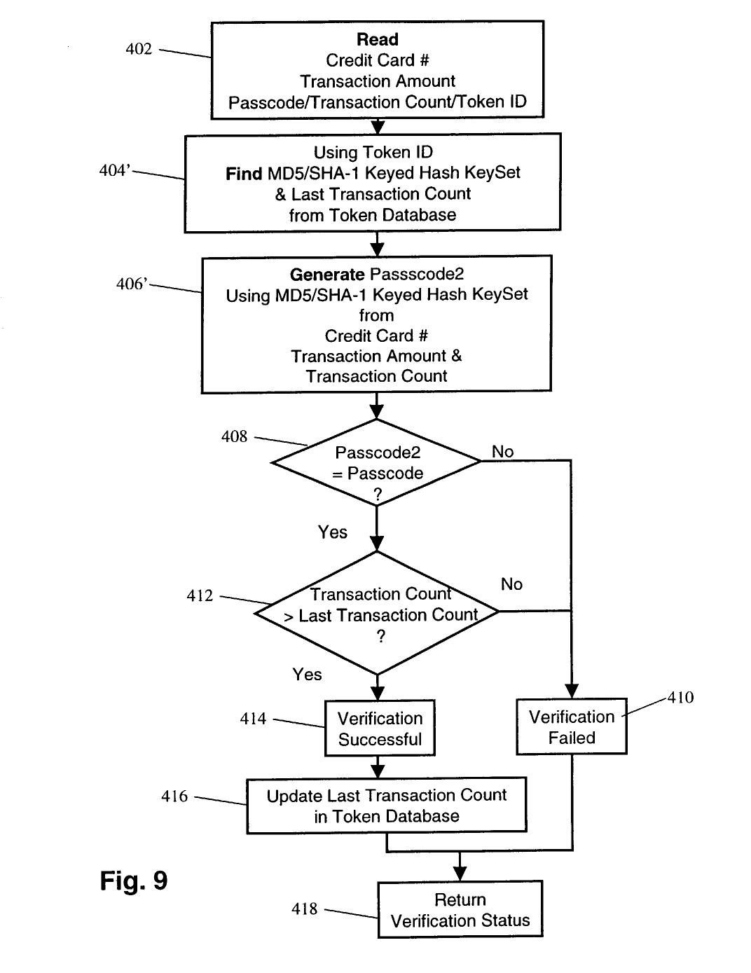

FIG. 9 illustrates a third embodiment of a process for verifying a transaction using a passcode.

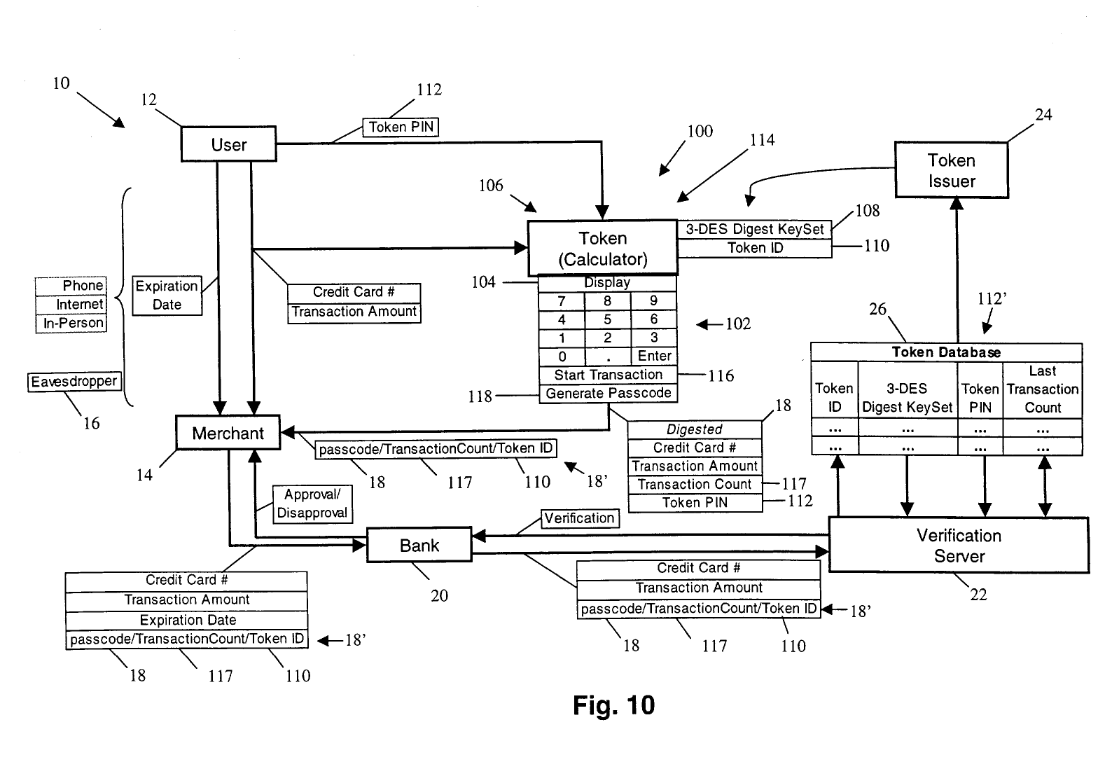

FIG. 10 illustrates a fourth embodiment of a transaction verification system;

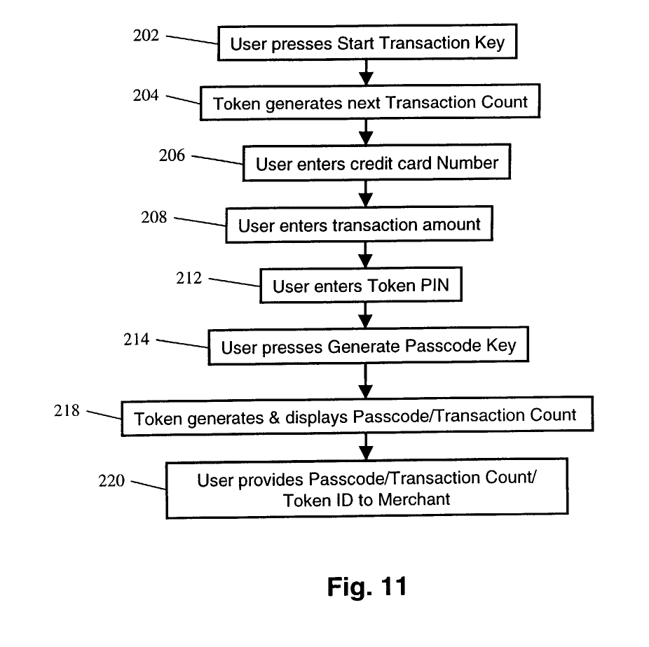

FIG. 11 illustrates a third embodiment of a process for generating a passcode used to verify a transaction;

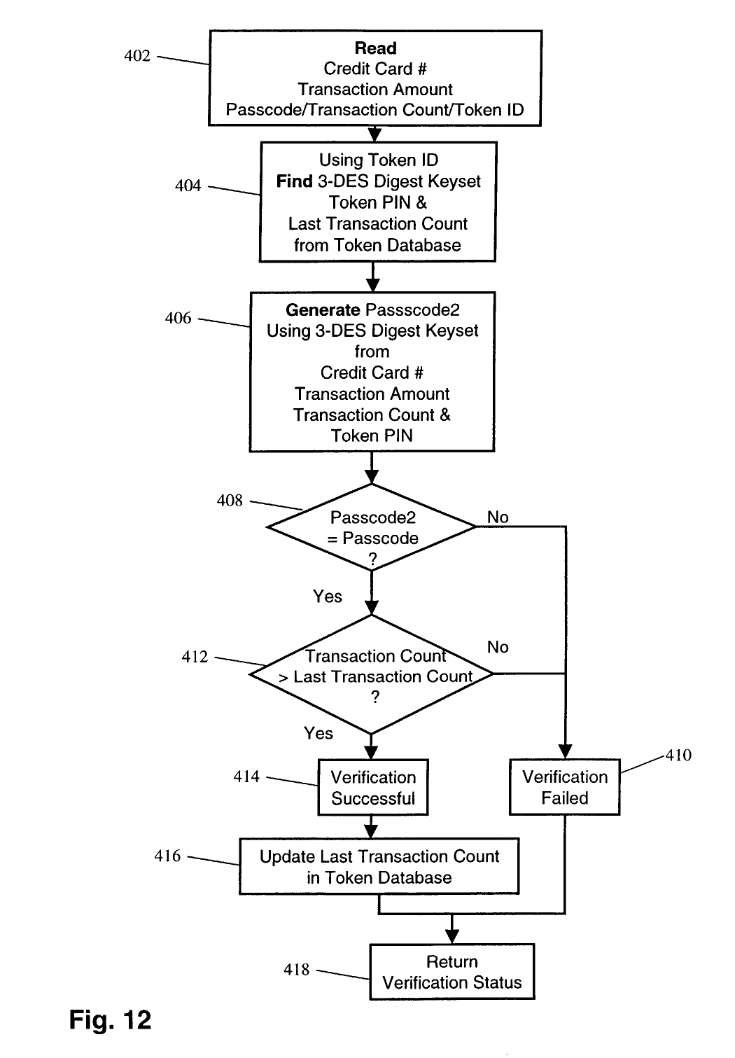

FIG. 12 illustrates a fourth embodiment of a process for verifying a transaction using a passcode.

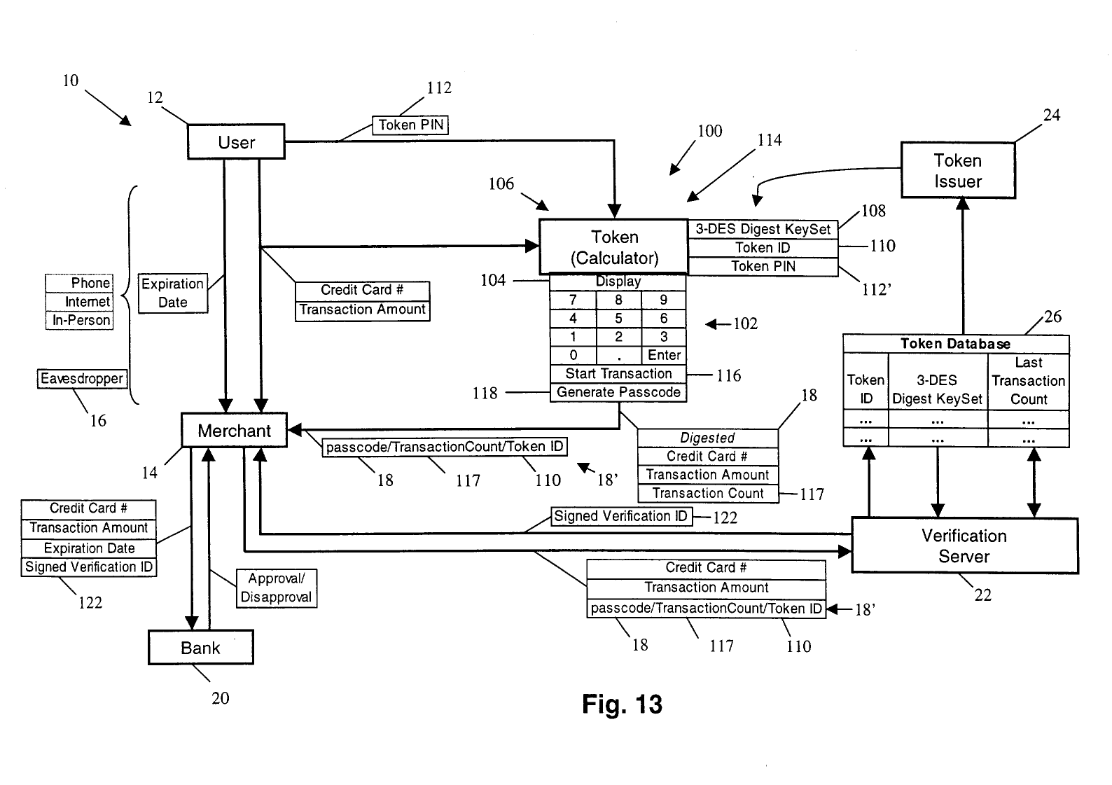

FIG. 13 illustrates a fifth embodiment of a transaction verification system;

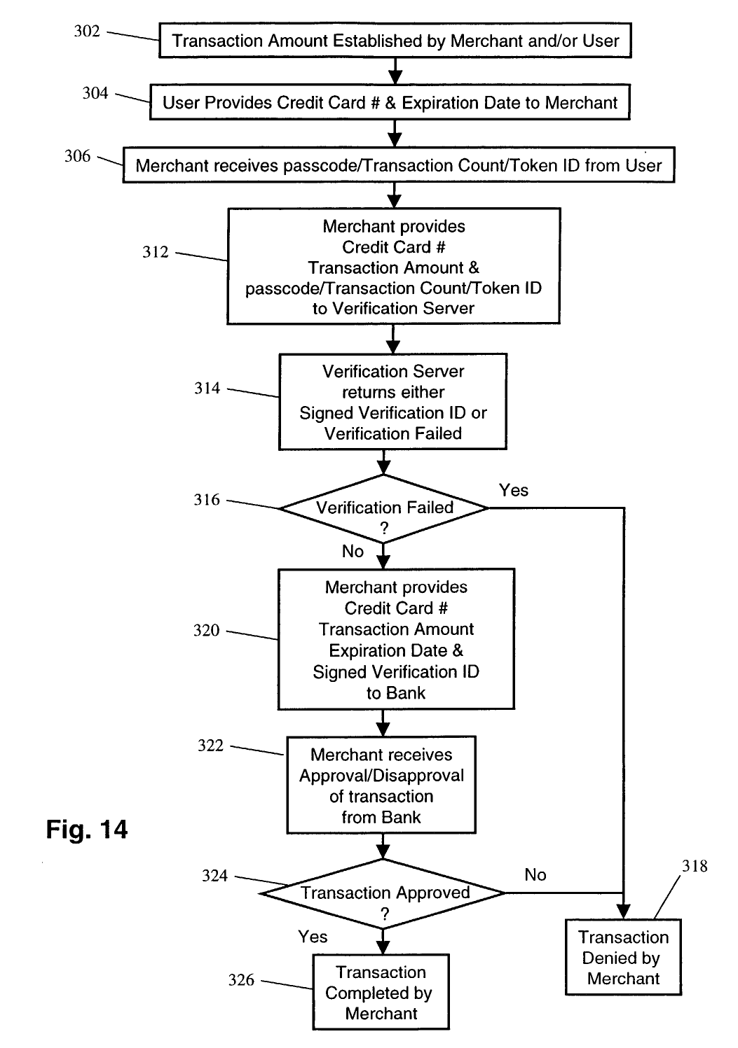

FIG. 14 illustrates a second embodiment of a process by which a merchant verifies a transaction;

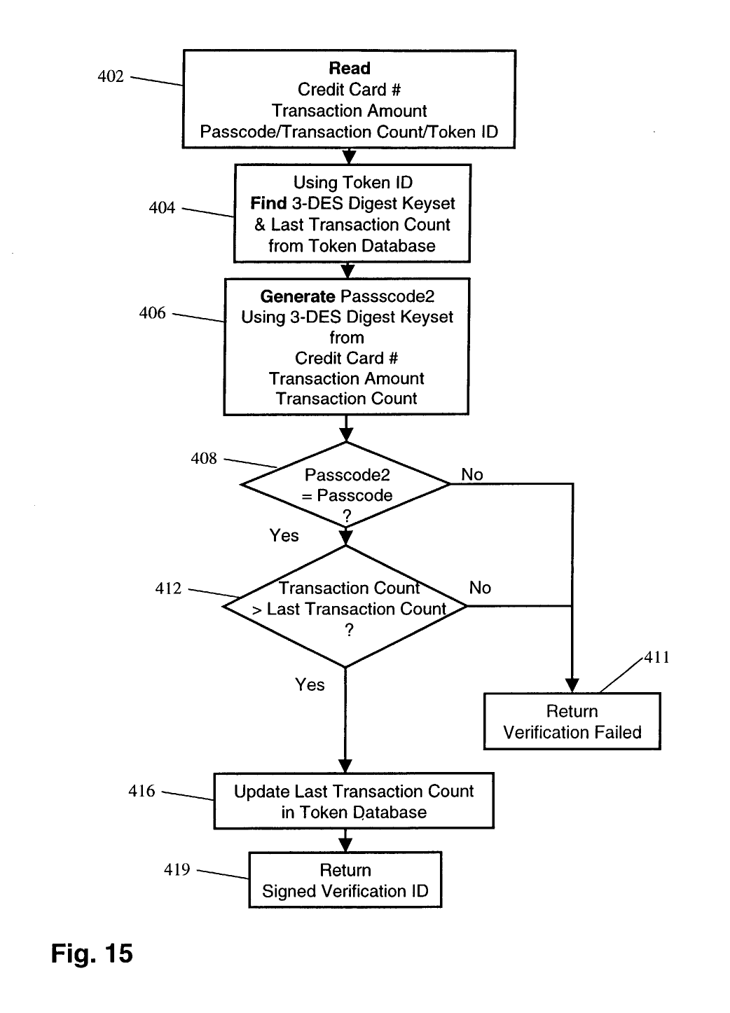

FIG. 15 illustrates a fifth embodiment of a process for verifying a transaction using a passcode;

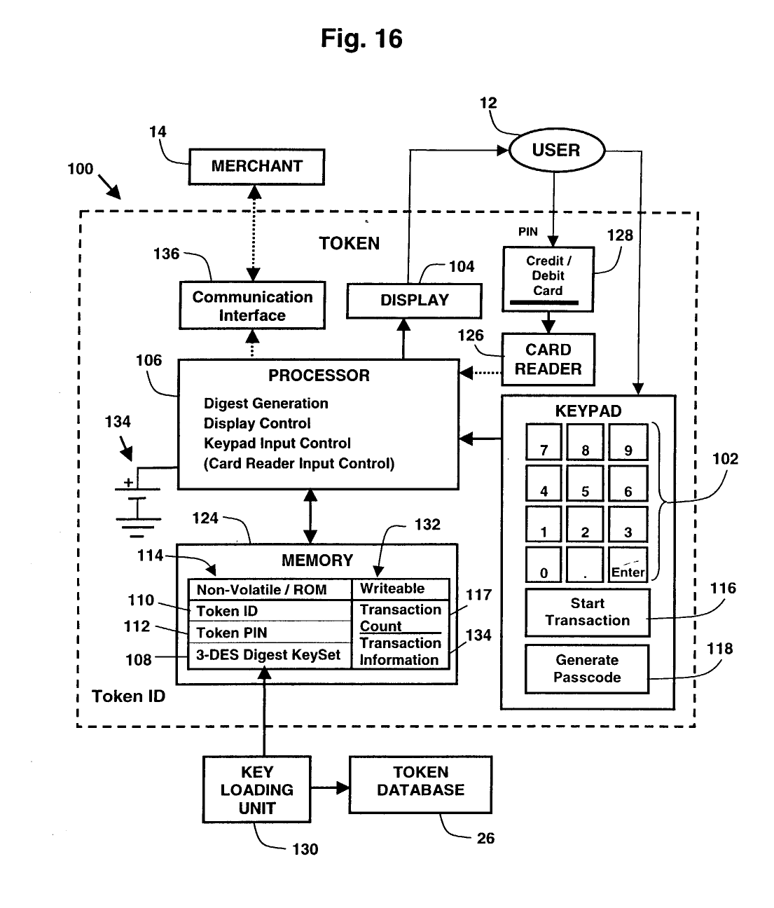

FIG. 16 illustrates a token for generating a passcode and a transaction count for use in a transaction verification system; and

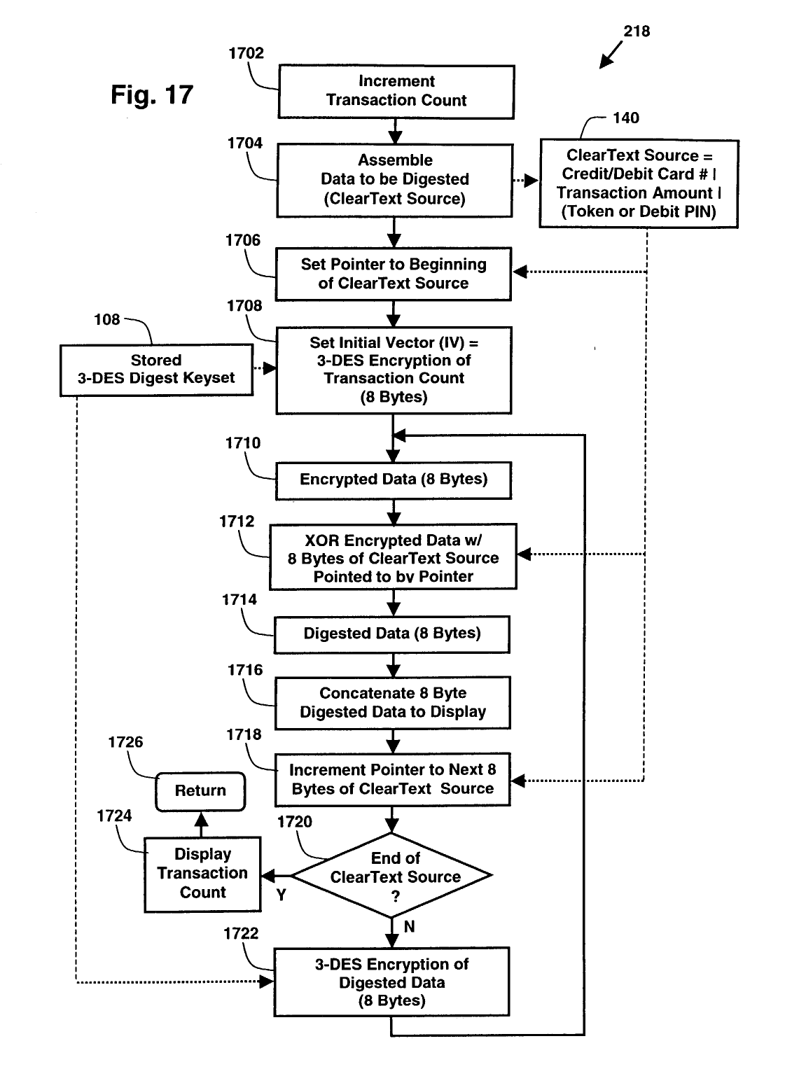

FIG. 17 illustrates a process by a token for generating a passcode and a transaction count.

Transactions using a credit cards as a monetary instrument may be susceptible to a variety of types of fraud. For many transactions, mere physical possession of a credit card, e.g. a stolen credit card—without further verification—is sufficient to finance the purchase. For example, mere possession of a credit card is sufficient to conduct a transaction involving an automatic credit card reader, for example, to operate a gasoline pump; or a transaction with a merchant who fails to verify the signature or who is unable to recognize that a signature is forged. In some cases, mere knowledge of a credit card number—e.g. a stolen credit card number that is published on the internet—is sufficient to effect a transaction, for example, when making a telephone call. In other cases, further knowledge of the associated expiration date is sufficient to conduct a transaction, for example, over the telephone or internet, particularly for services. In yet other cases, further knowledge of the associated credit card billing address is sufficient to conduct a transaction over the telephone or internet for a deliverable item.

Whereas most credit card fraud is perpetrated by a purchaser upon a merchant, the reverse is also possible, wherein the merchant surreptitiously increases the amount that is charged to a credit card for a given transaction or who submits repeated unauthorized transactions.

Some credit card companies have been offering one-time credit card numbers for internet purchases to reduce losses from credit card fraud. Various user registration schemes have also been suggested. However, these approaches can be inconvenient for the user, particularly for a user who has several credit cards. Accordingly, there exists a need for an improved system and method for reducing losses from credit card fraud.

Referring to FIG. 1, in a transaction verification system 10, a user 12 conducts a transaction with a merchant 14 and finances the transaction by payment of the transaction amount using a credit card that has an associated credit card number and an expiration date. After the transaction amount is determined, either unilaterally by the merchant 14 or through negotiation between the merchant 14 and the user 12; the user 12 provides either a credit card, or a number and expiration date associated therewith, to the merchant 14 for payment of the transaction. For example, the transaction may be conducted by voice or keypad over the phone, or via the internet using a computer or other internet access device, in which case, the transaction is financed by providing a credit card number and an expiration date, and possibly a billing address. Up to this point in the transaction process, without further precautions, the transaction would be susceptible to credit card fraud as indicated hereinabove.

The prospects for credit card fraud can be substantially reduced, by use of a token 100 that, for example, is not susceptible to tampering by either the merchant 14 or an eavesdropper 16. The token 100 generates a passcode 18, containing a keyed digest of the transaction, which is provided by the user 12 to the merchant 14, and which is passed on to a bank 20 for verification by a verification server 22. For example, the token 100 may comprise a calculator-like device having a keypad 102—comprising numeric keys 0-9, period (“.”), and “Enter”—and a display 104, e.g. an alphanumeric display, e.g. 12 to 24 characters long. The token 100 further comprises a processor 106 that reads the keypad 102; generates display prompts for user input; and using a secret, stored digest keyset 108, e.g. a 3-DES (triple Data Encryption Standard) keyset, digests the information entered by the user 12 responsive to the display prompts. The digested information is then displayed as a passcode 18 on the display 104.

For example, using a digest keyset 108 in accordance with a 3-DES process in cyclic block chaining (CBC) mode—typically called a Manipulation Detection Code, such as in ANSI X9.17—to calculate a resultant, or checksum, provides an eight (8) byte binary resultant that can be readily keyed-in by the user 12. As another example, keyed hashes based upon standard hash algorithms, e.g. MD5 or SHA-1, may be used to provide substantially larger resultants, e.g. 16 and 20 binary bytes, respectively, which, however, may be inconvenient to manually key in by the user 12. Generally, the process of digesting the transaction information may result in a loss of information, so that a single particular value of the passcode 18 could correspond to several different transactions. However, the likelihood of evasion of the verification process is extremely small, and is not possible by a single bit change to the associated cleartext information from which the passcode 18 is generated.

Different users 12 would have different tokens 100 that are serialized so that each has a unique token ID 110 and a unique digest keyset 108. For example, the token ID 110 could comprise a serial number of 12 to 16 digits. The token 100 also has a unique token Personal Identification Number (token PIN) 112 that is, ideally, known only to the user 12. The token ID 110, digest keyset 108, and token PIN 112 are stored in a non-volatile memory 114 in the token 100, and are provided by a token issuer 24 from a secure token database 26 that is indexed by token ID 110. For example, similar to the practice with credit cards, several digits of the token ID 110 could denote the token issuer 24.

Accordingly, the token issuer 24 could be identified from the token ID 110. By then looking up the address of the associated token issuer 24, the token issuer 24 could be contacted for verification, for example, that the token 100 is valid.

Referring to FIG. 2, in step (201), prior to the first use, the token 100 is initially enabled. Moreover, both a Successive Failure counter and a PIN Attempt counter internal to the token 100 are reset. In step (202), the user 12 commences operation of the token 100 by pressing the “Start Transaction” key 116, after which, if, in step (203), the token 100 is not disabled, then, in step (204), the token 100 generates the next transaction count 117, which is stored in memory. For example, the transaction count 117 may be generated by a four digit recirculating transaction counter in the token 100. Then, in step (206), responsive to a first display prompt on the display 104, the user 12 enters a credit card number, which is also provided as cleartext to the merchant 14. Then, in step (208), responsive to a second display prompt on the display 104, the user 12 enters the transaction amount that that was agreed upon by the merchant 14 and the user 12. Then, in step (210) the token 100 initializes a PIN Attempt counter that stores the number of consecutive unsuccessful attempts to generate a passcode 18 because of an incorrect token PIN 112, after which, in step (212), responsive to a third display prompt on the display 104, the user 12 enters the token PIN 112 associated with the token 100. The token PIN 112 is known by the user 12, but usually not known by the merchant 14. If the user 12 makes a mistake in any of these entries, then the process can be resumed beginning with step (206) by pressing the “Start Transaction” key 116. Alternately, if the keypad 102 were provided with associated scroll keys, the user could scroll through steps (206, 208 and 212) until satisfied that all of the associated data has been entered properly. Then, in step (214), the user 12 presses the “Generate Passcode” key 118. If, in step (216), the token PIN 112 entered by the user 12 corresponds to the stored token PIN 112′ of the token 100, then, in step (217) the Successive Failure counter and the PIN Attempt counter are each reset. Then, in step (218), the token 100 generates the passcode 18 by digesting the credit card number, transaction amount, and transaction count 117.

The passcode 18 and transaction count 117 are then displayed on the display 104, and, in step (220), the user provides the passcode 18, transaction count 117 and the token ID 110 to the merchant 14 for verification of the transaction. For example, in an internet transaction, the user 12 would type the passcode 18 into an appropriate field of the browser window, whereas in a telephone transaction, the user 12 would either recite the passcode 18, or key-in the passcode 18 using the telephone keypad. The passcode 18, transaction count 117 and the token ID 110 can be provided as separate quantities, or as a single quantity referred to as the composite passcode 18′, but which contains a cleartext token ID 110 portion, a cleartext transaction count 117 portion, and a digested passcode 18 portion.

The transaction count 117 is used to prevent repeated billings—for example, as might be submitted by an unscrupulous merchant 14—that have not been authorized by the user 12. For example, by digesting the credit card number and transaction amount, the resulting passcode 18 (digest) would be the same for transactions of the same value using the same credit card number. By using a transaction counter, sending the transaction count 117 value thereof in cleartext, and digesting the same value in the passcode 18, repeated transactions can be detected by comparing the transaction count 117 with the last (or previous) transaction count 117′, after verifying that the passcode 18 is consistent with the associated cleartext information, wherein a consistent passcode 18 indicates that the cleartext transaction count 117 has not been modified. The cleartext transaction count 117 can be appended to the passcode 18 as described hereinabove, thereby creating a composite passcode 18′ that is somewhat larger than the digest. If the composite passcode 18′ is to be enterable upon a telephone keypad, the binary data thereof could be mapped to a longer digit string.

From the point of view of the user 12, the transaction count 117 is just part of the passcode 18 (digest). For example, the display 104 might be adapted to display 6 groupings of 4 digits, for a total of 24 digits. The token ID 110 would constitute perhaps another 4 groupings of 4 digits, but the token ID 110 does not have to be displayed on the display 104 (although this is an option), as it can be printed on the housing of the token 100. Displaying the token ID 110 as well as the rest of the data provides the advantage of being unsusceptible to whether the token ID 110 was scratched or peeled off the token 100—as might be done innocently by a young child or pet; or intentionally by a vandal.

For the example of a transaction verification system 10 having a 4 digit transaction count 117, a 20 digit passcode 18, and a 12 to 16 digit token ID 110, the composite passcode 18′ would comprise up to 40 digits that the user would need to provide to the merchant 14. Having to enter a relatively large number of digits can be either inconvenient or annoying to the user 12. However, the number of digits that must be entered by the user could be reduced. For example, in a browser environment, the token ID 110 could be automatically provided by a “cookie” in the browser, thereby precluding the need for the entry thereof by the user, thereby reducing the number of digits to 24 in the above example. In a telephone environment—or a browser environment using the a microphone input to the computer with associated signal processing software—the token 100 could be provided with a dual tone multiple frequency (DTMF) module and a speaker, wherein with the speaker in range of the telephone microphone, the DTMF module could be used to automatically generate the tones associated with the digits of the composite passcode 18′, thereby precluding the need for the user 12 to enter any digits. Moreover, the information could be passed wirelessly to a computer or other receiver, for example, using radio frequency or infrared radiation.

Returning to FIG. 2, if, from step (216), the token PIN 112 entered by the user 12 does not correspond to the stored token PIN 112′ of the token 100, then, in step (222), the PIN Attempt counter is incremented. If, in step (224), the PIN Attempt counter does not exceed a threshold, then in step (226), the user 12 is prompted by a display prompt on the display 104 to enter the token PIN 112 again. Otherwise, from step (224), if the maximum number of attempts by the user 12 to enter the stored token PIN 112′ are exceeded, then, in step (228), the token 100 is disabled so as to prevent an unauthorized user 12 from conducting an exhaustive search for the stored token PIN 112′. The period of time over which the token 100 would be disabled can be limited so as to provide a compromise between security and convenience to the user 12. For example, following step (228), in step (230) the Successive Failure counter is incremented, after which the process repeats with step (202). Then, if, in step (203), if the token 100 is disabled, then, in step (232), if the period of time over which the token 100 has been disabled exceeds a threshold, then, in step (234), the token 100 is enabled and, in step (236), the PIN Attempt counter is reset, after which the above-described process resumes with step (204). Otherwise, from step (232), the process repeats with step (203). The time-out period may be adapted to be a function of the value of the Successive Failure counter. For example, with the first failure, the time-out period might be set to 12 hours, and then successively doubled or quadrupled with each successive failure, so as to dramatically limit an unauthorized person's ability to experimentally discover the stored token PIN 112′.

Referring to FIG. 3, from the perspective of the merchant 14, after the transaction amount is established by the merchant 14 and/or user 12 in step (302), in steps (304) and (306), the user provides the credit card number and the associated expiration date; and the composite passcode 18′ to the merchant 14, after which, in step (308), the merchant 14 then provides the credit card number, transaction amount, credit card expiration date, and the composite passcode 18′ (passcode 18, transaction count 117 and token ID 110) to a bank 20, e.g. the bank that issued the credit card.

Referring again to FIG. 1, the bank 20 forwards the credit card number, transaction amount, composite passcode 18′ (passcode 18, transaction count 117 and token ID 110) to a verification server 22, which verifies whether or not the cleartext credit card number and transaction amount are consistent with the corresponding digested values in the passcode 18. Stated another way, the bank 20 forwards the passcode 18, transaction count 117 and token ID 110, and the associated cleartext of information that is digested in the passcode 18 and that the bank 20 wishes to have verified by a verification process performed by the verification server 22.

Referring to FIG. 4, from the perspective of the verification server 22, the verification server 22 commences the verification process in step (402) by reading the credit card number, transaction amount, passcode 18, transaction count 117 and token ID 110 from the data transmitted thereto by the bank 20. For example, the verification server 22 can extract the cleartext transaction count 117 from the composite passcode 18′ provided by the bank 20 from the merchant 14 from the user 12. Then, in step (404), the verification server 22 uses the token ID 110 as an index to look-up the 3-DES digest keyset 108 and the last transaction count 117′ of the associated token 100. Then, in step (406), the verification server 22 generates its own version of the passcode 18—denoted passcode2 —using the associated 3-DES digest keyset 108. If, in step (408), the value of passcode2 generated by the verification server 22 differs from the value of the passcode 18 provided by the user 12, then, in step (410), a verification status is set to UNSUCCESSFUL. Otherwise, if, in step (412), the last transaction count 117′ is less than or equal to the current transaction count 117—thereby indicating a repeated transaction—then, in step (410), the verification status is also set to UNSUCCESSFUL Otherwise, from step (412), in step (414), the verification status is set to SUCCESSFUL, and, in step (416), token database 26 is updated to set the last transaction count 117′ equal to the current transaction count 117. Then, from either steps (410) or (416), in step (418), the verification server 22 returns the verification status to the bank 20. Referring again to FIG. 3, in step (310), if the verification status is UNSUCCESSFUL, if the user 12 does not have sufficient credit, if the expiration date of the credit card has been exceeded, or if the credit card is otherwise invalid, then the bank 20 indicates to the merchant 14 that the transaction is DISAPPROVED. Otherwise, the bank 20 indicates to the merchant 14 that the transaction is APPROVED. In the case of a recirculating transaction counter, the comparison test of step (412) would be adapted to properly account for when the counter rolls over, for example, by treating large negative differences between the current transaction count 117 and the last transaction count 117′ as positive.

Since the passcode 18 is dependent upon the transaction amount, the transaction count 117, and the secret digest keyset 108 of the token 100, the merchant 14 is unable to successfully change the transaction amount or issue repeated transactions without consent of the user 12.

While not providing “card present” proof that credit card was actually in possession of the user 12, the above described transaction verification system 10 does provide “token present” proof that the token 100 was in possession of the particular user 12, authorized to use the token 100 on the basis of associated knowledge of the associated token PIN 112.

In another embodiment, the token 100 could incorporate a magnetic card reader for reading the credit card information—including the credit card number and the expiration date—from the tracks of the magnetic stripe thereon, thereby precluding the need for the user 12 to enter this information as described hereinabove. Otherwise, the operation of the transaction verification system 10 would be the same as described hereinabove. Moreover, all of the track information from the credit card could be digested in the passcode 18, rather than just the credit card number. The verification server 22 could then be adapted to accommodate and verify whatever track information would be included in the passcode 18 and also sent either in cleartext from the merchant 14 to the bank 20 to the verification server 22, or from the bank 20 to the verification server 22 bases upon data stored by the bank 20 about the associated credit card. Accordingly, a token 100 incorporating a magnetic card reader would give proof of “card present” as well as “token present”.

The security of the transaction verification system 10 may be further enhanced if the verification server 22 were to generate a random challenge (a random number) that would be communicated back to the user 12, responsive to which the user 12 would enter the random number of the random challenge into the token 100 along with their token PIN 112, and then generate an associated passcode 18 by pressing the “Generate Passcode” key 118. The user 12 would then type in the generated passcode 18 as a one-time password. One limitation of this approach is that the challenge and the response would need to be rather large numbers (e.g. 12 to 16 digits) in order to prevent a “birthday problem” reuse of identical challenges and responses. Such a random challenge by the verification server 22 would eliminate the need for the transaction counter, but would require a change in existing transaction protocols. Accordingly, the incorporation of a transaction counter in the token 100 helps to simplify the overall system.

In general, transaction verification system 10 provides for improved transaction security by incorporating a token 100 that is unsusceptible to remote attack—for example by an eavesdropper 16 or hacker—via the communications link between the user 12 and the merchant 14. The token 100 incorporates a secret digest keyset 108 that is known only to the token issuer 24 and the verification server 22 via a token database 26. The token 100 also incorporates a secret token PIN 112 that is known only to user 12, the token issuer 24 and possibly the verification server 22—the later two via the token database 26. Accordingly, the token PIN 112 restricts access to substantially only an authorized user 12—an unauthorized used would need to be extraordinarily lucky to guess the token PIN 112 in the limited number of authorized attempts. The token 100 digests a set of information that is also sent in cleartext, and the verification server 22 verifies whether or not the digested information matches the corresponding information that is sent in cleartext. Substantially any attempt to change the digested or cleartext information along the information flow path from the user 12 to the verification server 22 would highly likely be detected by the verification server 22 and would thereby prevent a successful verification of the transaction by the verification server 22. Accordingly, provided that the return communication paths from the verification server 22 to the bank 20, and from the bank 20 to the merchant 14, are secure, then the overall transaction verification system 10 would be secure.

Referring to FIGS. 5, 6 and 7, the transaction verification system 10 may be adapted to accommodate a debit/ATM card by modifying the corresponding system and processes illustrated in FIGS. 1, 2 and 4 respectively, as follows. Referring to FIG. 6, after step (208) and before step (210), in step (209), responsive to a display prompt on the display 104, the user 12 enters the debit card PIN with the keypad 102 of the token 100, which is then included in the information that is digested by the token 100 in step (218) when the token 100 generates the passcode 18. The debit card PIN is secret to the user 12 and the bank 20 that issued the debit/ATM card. The bank 20 encrypts the debit card PIN using an associated secret debit card encryption keyset. Referring to FIG. 7, in step (402), the bank 20 provides the encrypted debit card PIN to the verification server 22, which, in step (405), following step (404), decrypts the encrypted debit card PIN using the same secret debit card encryption keyset used by the bank 20, and provided thereby to the verification server 22 over a secure channel. Then, in step (406), the verification server 22 generates its own version of the passcode 18—denoted passcode2—using the associated 3-DES digest keyset 108 operating upon the credit card number, transaction amount, transaction count 117 and the cleartext debit card PIN—as had been digested by the token 100. The verification process then proceeds as has been described hereinabove for FIG. 4, wherein a SUCCESSFUL verification would indicate that the debit card PIN provided by the user 12 matched the corresponding debit card PIN of the debit/ATM card. Accordingly, by using the bank 20 to provide an encrypted debit card PIN, the debit card PIN is not compromised as would otherwise occur if the debit card PIN were to be provided to the merchant 14 in cleartext embedded within a composite passcode 18′. The transaction verification system 10 otherwise operates as described hereinabove for the embodiment of FIGS. 1-4.

Referring to FIGS. 8 and 9, the transaction verification system 10 may be adapted to accommodate a keyed hash process for generating the passcode 18 by modifying the system and process illustrated in FIGS. 1 and 4 respectively, wherein the keyed hash process differs from the above-described digest process using a Manipulation Detection Code in that the associated keyed hash keyset 120, e.g. MD5 or SHA-1, is encoded in the passcode 18, and used by the verification server 22 in steps (404′) and (406′) of FIG. 9, instead of a 3-DES digest keyset 108. The transaction verification system 10 otherwise operates as described hereinabove for the embodiment of FIGS. 1-4.

In the above described embodiments, the token PIN 112 is used to enable operation of the token 100. Referring to FIGS. 10, 11 and 12, the transaction verification system 10 may be adapted to have the verification server 22—rather than the token 100—check for a valid token PIN 112, by modifying the system and processes illustrated in FIGS. 1, 2 and 4 respectively. With this embodiment, the token 100 need not necessarily even know the associated stored token PIN 112′, as this could be recorded in the associated token database 26. This arrangement would have the benefit of not letting an unauthorized user 12 know whether or not the token PIN 112 entered by them was valid, but with the associated limitation of precluding the authorized user 12 from recognizing data entry mistakes as they occur.

Referring to FIG. 11, from the perspective of the user 12, in step (202), the user 12 commences operation of the token 100 by pressing the “Start Transaction” key 116, after which, in step (204), the token 100 generates the next transaction count 117 that is stored in memory. For example, the transaction count 117 may be generated by a four digit recirculating transaction counter in the token 100. Then, in step (206), responsive to a first display prompt on the display 104, the user 12 enters the credit card number, that is also provided as cleartext to the merchant 14. Then, in step (208), responsive to a second display prompt on the display 104, the user 12 enters the transaction amount that that was agreed upon by the merchant 14 and the user 12. Then, in step (212), responsive to a third display prompt on the display 104, the user 12 enters the token PIN 112 associated with the token 100. Then, in step (214), the user 12 presses the “Generate Passcode” key 118. Then, in step (218), the token 100 generates the passcode 18 by digesting the credit card number, transaction amount, and transaction count 117. The passcode 18 and transaction count 117 are then displayed on the display 104, and in step (220), the user provides the passcode 18, transaction count 117 and the token ID 110 to the merchant 14 for verification of the transaction.

Referring to FIG. 12, from the perspective of the verification server 22, following step (402) as described hereinabove for FIG. 4, in step (404) the verification server 22 uses the token ID 110 to find the token PIN 112 from the token database 26. The verification process then proceeds as has been described hereinabove for FIG. 4, wherein a SUCCESSFUL verification would indicate that the token PIN 112 provided by the user 12 matched the corresponding stored token PIN 112′ of the token database 26.

The transaction verification system 10 otherwise operates as described hereinabove for the embodiment of FIGS. 1, 3 and 4.

Referring to FIGS. 13, 14 and 15, the transaction verification system 10 may be adapted to accommodate transaction verification by a verification server 22 at the direct request of the merchant 14, followed by transaction approval by the bank 20. Referring to FIGS. 14, from the perspective of the merchant 14, after the transaction amount is established by the merchant 14 and/or user 12 in step (302), in steps (304) and (306), the user provides the credit card number and the associated expiration date; and the composite passcode 18′ to the merchant 14. The merchant 14 can determine the address of the token issuer 24/verification server 22 from the token ID 110 as described hereinabove. Then, in step (312), the merchant 14 sends the credit card number, transaction amount and composite passcode 18′ to the verification server 22 for verification thereof. Referring to FIGS. 14 and 15, if, in step (316) from step (411), the verification was UNSUCCESSFUL, then in step (318) the transaction is denied to the user 12 by the merchant 14. Otherwise, if, from step (408), the passcode 18 is equal to the generated passcode2, and if from step (412) the transaction has not been repeated, then in step (419) the verification server 22 creates a unique transaction verification ID, and signs this with a key known to the bank 20 (credit card issuer), so that the bank 20 can verify that the transaction has been locked and verified by the transaction verification system 10. Then, in step (320), the merchant 14 provides the credit card number, transaction date, credit card expiration date and the signed verification ID 122 to the bank 20, which, in step (322), indicates to the merchant 14 whether the transaction has been approved or disapproved. If, in step (324), the bank 20 has approved the transaction, then, in step (326), the transaction is completed by the merchant 14. Otherwise, in step (318), the transaction is denied to the user 12 by the merchant 14. The transaction verification system 10 otherwise operates as described hereinabove for the embodiment of FIGS. 1, 2 and 4.

It should be understood that the above-described embodiments can be combined to provide other embodiments. For example, the embodiments of FIGS. 5 and 10 could be combined so as to provide a transaction verification system 10 for processing debit/ATM cards wherein the verifications of both the token PIN 112 and the debit card PIN are both performed exclusively by the verification server 22.

Referring to FIG. 16, the token 100 is illustrated in greater detail, comprising a processor 106 and an associated memory 124; a display 104, e.g. an alphanumeric display, e.g. 12 to 24 characters long; a keypad 102—comprising numeric keys 0-9, period (“.”), and “Enter”; a “Start Transaction” key 116, and a “Generate Passcode” key 118. The “Start Transaction” key 116, when activated, causes the processor 106 to display a prompt message on the display 104, prompting the user 12 to enter information related to the display prompt, thereafter repeating the process until all of the necessary information is entered. Information is typically entered with the keypad 102, although the token 100 may further comprise a card reader 126 so as to provide for reading information from the magnetic stripe of either a credit or debit card 128. The memory 124 comprises non-volatile memory 114 within which is stored 1) an identification number—i.e. the token ID 110—associated with the token 100, which may also be imprinted on the outside of the token 100; 2) a personal identification number, i.e. the token PIN 112, associated with the token 100 known by the user 12 of the token 100; and a digest keyset 108, e.g. a 3-DES digest keyset. The digest keyset 108 is loaded by a key loading unit 130 on the token 100 and in the token database 26, and is otherwise kept secret. The token 100 may be adapted so that the processor 106, when opened or tampered with, automatically erases the digest keyset 108 so as to provide for improved security of the digest keyset 108, although this is not essential. The memory 124 further comprises a writeable memory 132, e.g. static RAM, that can be both read from and written to by the processor 106, and which is retained when the token 100 is not in use. For example, the contents of the writeable memory 132 may be retained by a battery power supply 134 of the processor. Whereas the processor 106 and memory 124 are illustrated as separate elements, it should be understood that both of these elements can be incorporated in a single integrated circuit. A transaction count 117 is stored in the writeable memory 132, as is, at least temporarily, the information related to the transaction to be verified—i.e. the transaction information 136, e.g. an identification number of a financial instrument such as a credit or debit card 128, the amount of the transaction, and possibly a personal identification number associated with the financial instrument—that is entered with the keypad 102 or card reader 126 responsive to display prompts on the display 104, under control of the processor 106. The “Generate Passcode” key 118, when activated, causes the processor 106 to increment the transaction count 117, and to generate a passcode 18 from the transaction information 136, the transaction count 117, and possibly the token PIN 112. The passcode 18, transaction count 117 and possibly the token ID 110 are then displayed on the display 104 for use by the user 12 in providing for verification of the transaction. This data may alternately or additionally be transmitted automatically via a communication interface 138 to another computer system, e.g. to a computer of a merchant 14, e.g. via either a direct connection, e.g. a cable, a telephone connection, e.g. using a dual tone multiple frequency modulation of an acoustic signal, or wirelessly using either a radio frequency, optical, infrared or acoustic carrier wave.

Referring to FIG. 17, the process 218 for generating the passcode 18 commences with step (1702), wherein the transaction count 117 is first incremented. Then, in step (1704) the information to be digested, e.g. the transaction information 136 and possibly the token PIN 112, is assembled, e.g. concatenated, in a cleartext source string 140, after which, in step (1706), a pointer is initialized to point to the beginning of the cleartext source string 140. Then, beginning in step (1708), a 3-DES encryption process is used to calculate a Manipulation Detection Code (MDC) by Cyclic Block Chaining (CBC) encryption of the information in the cleartext source string 140. More particularly, in step (1708), the initial vector (IV) for the 3-DES CBC encryption is calculated by encrypting the transaction count 117 using the stored 3-DES digest keyset 108 as keys for the associated 3-DES encryption process, which provides, in step (1710), resulting encrypted data that is 8 bytes long. In step (1712), this encrypted data is combined by exclusive OR (XOR) with 8 bytes of the cleartext source string 140 that are pointed to by the pointer, resulting, in step (1714), in a corresponding 8 bytes of associated digested data, which, in step (1716), are concatenated to the data being displayed as the passcode 18 on the display 104. Then, in step (1718), the pointer is incremented to point to the next 8 bytes of the cleartext source string 140. If, in step (1720), the pointer is not pointing to or beyond the end of the cleartext source string 140, then, in step (1722), the 8 bytes of digested data from step (1714) is encrypted with the stored 3-DES digest keyset 108, and the process repeats with step (1710) until the end of the cleartext source string 140, whereupon, in step (1724), the transaction count 117 is displayed on the display 104, and the process ends in step (1726). By using the 3-DES encryption of the transaction count 117 as the initial vector (IV) for the 3-DES CBC encryption, an attacker will not know the initial vector (IV) that starts the digest process, which is more secure than having a known initial vector (IV). However, it would also be possible to use a null or programmatic initial vector (IV) and include the transaction count 117 in the information to be digested. If the output of the token 100 is displayed in hexadecimal format, a transaction count of 0 to 64 K could be displayed with 4 bytes, whereas 16 bytes would provide for displaying the full digest. Credit card numbers are typically 16 bytes long. Accordingly, a 20 character display 104 may be of sufficient length for verification of credit card transactions.

Whereas the transaction verification system 10 has been illustrated for verifying credit card transactions, it should be understood that the transaction verification system 10 can be used in other applications requiring verification that information has been provided by a particular authorized user 12. For example, the transaction verification system 10 may be used to generate a one-time password—from a password and token PIN 112, both known to a user 12—for access to a computer system or service.

The above-described transaction verification system 10 provides a security functionality that is similar to that offered by smart cards, while still operating on or with legacy equipment and systems that are unable to utilize such smart cards. The transaction verification system 10 provides a relatively stronger assurance to the user 12 of proper behavior by the merchant 14 than does usage of known chip cards from untrusted devices, such as personal computers The transaction verification system 10 can be used for telephone orders, where digital interfaces are not available and where ATM/debit transactions are presently not adequately protected. The transaction verification system 10 works with multiple credit cards and does not require an investment in expensive chip card technology.

While specific embodiments have been described in detail, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

I claim:

1. A method of providing for verifying a transaction, comprising:
a. providing for receiving into a token an identification number of a financial instrument, wherein said token comprises a processor and a memory, and said processor provides for storing the received information in said memory;
b. providing for receiving into said token a transaction amount of a transaction to be financed by said financial instrument;
c. providing for receiving into said token a personal identification number associated with said token;
d. providing for incrementing a transaction count stored in said memory;
e. providing for generating a passcode, wherein said passcode comprises a digest of said identification number of said financial instrument, said transaction amount and said transaction count, and said digest is responsive to an encryption process responsive to a digest keyset that is stored in said memory; and
f. providing for displaying said passcode and said transaction count on a display associated with said token.

2. A method of providing for verifying a transaction as recited in claim 1, wherein said financial instrument comprises either a credit card or a debit card.

3. A method of providing for verifying a transaction as recited in claim 1, further comprising providing for receiving into said token a personal identification number associated with said financial instrument, wherein said passcode further comprises a digest of said personal identification number associated with said financial instrument.

4. A method of providing for verifying a transaction as recited in claim 1, wherein said transaction amount and said personal identification number associated with said token are received into said token from a keypad operated by a user.

5. A method of providing for verifying a transaction as recited in claim 1, wherein said identification number of said financial instrument is received into said token from a keypad operated by a user.

6. A method of providing for verifying a transaction as recited in claim 2, wherein said identification number of said financial instrument is received into said token from a credit card reader operatively associated with said token.

7. A method of providing for verifying a transaction as recited in claim 6, further comprising receiving supplemental information from said financial instrument into said token from said credit card reader.

8. A method of providing for verifying a transaction as recited in claim 1, wherein said digest keyset comprises a triple Data Encryption Standard (3-DES) digest keyset, and said encryption process comprises a 3-DES encryption of said transaction count as an initial vector for a 3-DES encryption process using a cyclic block chaining (CBC) mode to generate a manipulation detection code (MDC) from information being digested.

9. A method of providing for verifying a transaction as recited in claim 1, wherein said digest keyset comprises a keyed hash keyset of either an MD5 or SHA-1 encryption process, and said passcode further comprises a digest of said keyed hash keyset.

10. A method of providing for verifying a transaction as recited in claim 1, wherein said passcode further comprises a digest of said personal identification number associated with said token.

11. A method of providing for verifying a transaction as recited in claim 1, further comprising displaying a user prompt on said display prior to receiving information into said token.

12. A method of providing for verifying a transaction as recited in claim 1, further comprising providing for displaying on said display said identification number associated with said token.

13. A method of providing for verifying a transaction as recited in claim 1, further comprising inhibiting an operation of said token if said personal identification number associated with said token does not correspond to a personal identification number stored in said token.

14. A method of providing for verifying a transaction as recited in claim 1, further comprising providing for automatically transferring to an external computer system at least one of said passcode, said transaction count, and said identification number of said token.

15. A method of providing for verifying a transaction as recited in claim 14, wherein the operation of automatically transferring at least one of said passcode, said transaction count and an identification number of said token to an external computer system is done wirelessly using wave energy.

16. A method of providing for verifying a transaction as recited in claim 15, wherein said wave energy is selected from radio frequency electromagnetic wave energy, optical wave energy, infrared wave energy, acoustic wave energy.

17. A method of verifying a transaction, comprising:
a. establishing a transaction amount of a transaction with a user to be paid with a financial instrument used by said user;
b. receiving an identification number of said financial instrument from said user;
c. receiving an expiration date of said financial instrument from said user;
d. receiving a passcode from said user, wherein said passcode is generated by a token in possession of said user, said passcode comprises a digest of said identification number of said financial instrument, said transaction amount and a transaction count;
e. receiving said transaction count from said user;
f. receiving an identification number of said token from said user;
g. transmitting said identification number of said financial instrument and said transaction amount to at least one third party computer system;
h. transmitting said expiration date to a third party computer system of a bank that issued said financial instrument;
i. transmitting said passcode, said transaction count, and said identification number of said token to at least one third party computer system;
j. receiving an authorization decision from said third party computer system of said bank, wherein said authorization decision is responsive to a verification of said transaction, wherein said verification is dependent upon whether said passcode is consistent with said identification number of said financial instrument, said transaction amount, said transaction count and said identification number of said token, and whether said expiration date has been exceeded; and
k. determining responsive to said authorization decision whether or not to authorize said transaction.

18. A method of verifying a transaction as recited in claim 17, wherein said financial instrument comprises either a credit card or a debit card.

19. A method of verifying a transaction as recited in claim 17, wherein said identification number of said financial instrument, said transaction amount, said passcode, said transaction count, and said identification number of said token are transmitted to said third party computer system of said bank.

20. A method of verifying a transaction as recited in claim 17, wherein said identification number of said financial instrument and said transaction amount are transmitted to both said third party computer system of said bank, and to a third party computer system of a verification server; and said passcode, said transaction count, and said identification number of said token are transmitted to said verification server, further comprising receiving a signed verification identifier from said verification server and transmitting said signed verification identifier to said third party computer system of said bank, wherein said identification number of said financial instrument, said transaction amount, said passcode, said transaction count, and said identification number of said token are transmitted to said third party computer system of said bank, and said signed verification identifier is indicative of whether or not said passcode is consistent with said identification number of said financial instrument, said transaction count and said identification number of said token.

21. A method of verifying a transaction, comprising:
a. receiving from a merchant an identification number, wherein said identification number is of a financial instrument being used by a user to finance a transaction;
b. receiving from said merchant an expiration date of said financial instrument;
c. receiving from said merchant information about a transaction amount of said transaction being financed with said financial instrument;
d. receiving from said merchant a passcode, wherein said passcode is generated by a token in possession of said user, said passcode comprises a digest of said identification number of said financial instrument, said transaction amount and a transaction count;
e. receiving from said merchant said transaction count;
f. receiving from said merchant an identification number of said token;
g. transmitting said identification number of said financial instrument, said transaction amount, said passcode, said transaction count, and said identification number of said token to a third party computer system;
h. receiving from said third party computer system a verification decision, wherein said verification decision is responsive to a verification of said transaction, wherein said verification is dependent upon whether said passcode is consistent with said identification number of said financial instrument, said transaction amount, said transaction count and said identification number of said token;
i. determining responsive to said verification decision and to whether said expiration date is exceeded, an authorization decision of whether or not to authorize said transaction; and
j. transmitting said authorization decision to said merchant.

22. A method of verifying a transaction as recited in claim 21, wherein said financial instrument comprises either a credit card or a debit card.

23. A method of verifying a transaction as recited in claim 21, further comprising transmitting an encrypted personal identification number associated with said financial instrument to said third party computer system, wherein said encrypted personal identification number is encrypted in accordance with an encryption process such that said personal identification number can be decrypted by said third party computer system, and said verification is further dependent upon whether said passcode is consistent with said personal identification number associated with said financial instrument.

24. A method of verifying a transaction, comprising:
a. receiving from a merchant an identification number, wherein said identification number is of a financial instrument being used by a user to finance a transaction;
b. receiving from said merchant an expiration date of said financial instrument;
c. receiving from said merchant information about a transaction amount of said transaction being financed with said financial instrument;
d. receiving from said merchant a signed verification identifier, wherein said signed verification identifier is transmitted to said merchant by a third party computer system responsive to a verification of whether a passcode generated by a token in possession of said user is consistent with said identification number of said financial instrument, said transaction amount, a transaction count provided by said user, and an identification number of said token; and said identification number of said financial instrument, said transaction amount, said passcode, said transaction count and said identification number of said token are provided by said merchant to said third party computer system;
e. determining responsive to said signed verification identifier and to whether said expiration date is exceeded, an authorization decision of whether or not to authorize said transaction; and
f. transmitting said authorization decision to said merchant.

25. A method of verifying a transaction as recited in claim 24, wherein said financial instrument comprises either a credit card or a debit card.

26. A method of verifying a transaction, comprising:
a. receiving from a computer system an identification number of a financial instrument, a transaction amount of a transaction being conducted by a user with a merchant, a first passcode generated by a token in possession of said user, a transaction count, and an identification number of said token, wherein said first passcode comprises a digest of said identification number of said financial instrument, said transaction amount and said transaction count;
b. retrieving from a database a digest keyset and a last transaction count, wherein said operation of retrieving is from a record of said database corresponding to said identification number of said token;
c. generating a second passcode, wherein said second passcode comprises a digest of said identification number of said financial instrument, said transaction amount and said transaction count, and said digest is responsive to an encryption process responsive to said digest keyset;
d. generating a verification decision, wherein said verification decision is responsive to a comparison of said first and second passcodes, and to a comparison of said transaction count with said last transaction count, whereby said transaction is not verified unless said first and second passcodes are equal to one another and said transaction count is greater than said last transaction count;
e. transmitting said verification decision to said computer system; and
f. modifying said database by setting said last transaction count in said record equal to said transaction count.

27. A method of verifying a transaction as recited in claim 26, wherein said computer system is of a financial institution that issued said financial instrument.

28. A method of verifying a transaction as recited in claim 26, wherein said computer system is of said merchant conducting the transaction with said user.

29. A method of verifying a transaction as recited in claim 26, wherein said financial instrument comprises either a credit card or a debit card.

30. A method of verifying a transaction as recited in claim 26, further comprising:
a. receiving from said computer system an encryption of a personal identification number associated with said financial instrument, and
b. decrypting said personal identification number associated with said financial instrument, wherein said second passcode further comprises a digest of said personal identification number associated with said financial instrument.

31. A method of verifying a transaction as recited in claim 26, wherein said digest keyset comprises a triple Data Encryption Standard (3-DES) digest keyset, and said encryption process comprises a 3-DES encryption of said transaction count as an initial vector for a 3-DES encryption process using a cyclic block chaining (CBC) mode to generate a manipulation detection code (MDC) from information being digested.

32. A method of verifying a transaction as recited in claim 26, wherein said digest keyset comprises a keyed hash keyset of either an MD5 or SHA-1 encryption process, and said second passcode further comprises a digest of said keyed hash keyset.

33. A method of verifying a transaction as recited in claim 26, wherein said second passcode further comprises a digest of a personal identification number associated with said token.

34. A method of verifying a transaction as recited in claim 26, wherein the operation of transmitting said verification decision comprises transmitting a signed verification identifier to said computer system, wherein said signed verification identifier is signed in accordance with an encryption process that is known to said computer system.

35. A computer data signal embodied in a transmission medium, comprising:
a. a data segment including an identification number of a financial instrument;
b. a data segment including a transaction amount of a transaction being conducted by a user with a merchant;
c. a data segment including a passcode generated by a token in possession of said user, wherein said passcode comprises a digest of said identification number of said financial instrument, said transaction amount and a transaction count, and said digest is responsive to an encryption process responsive to a digest keyset;
d. a data segment including said transaction count; and
e. a data segment including an identification number of said token.

36. A computer data signal embodied in a transmission medium as recited in claim 35, wherein said digest keyset comprises a triple Data Encryption Standard (3-DES) digest keyset, and said encryption process comprises a 3-DES encryption of said transaction count as an initial vector for a 3-DES encryption process using a cyclic block chaining (CBC) mode to generate a manipulation detection code (MDC) from information being digested.

37. A computer data signal embodied in a transmission medium as recited in claim 35, wherein said digest keyset comprises a keyed hash keyset of either an MD5 or SHA-1 encryption process, and said second passcode further comprises a digest of said keyed hash keyset.

38. A computer data signal embodied in a transmission medium as recited in claim 35, wherein said passcode further comprises digest of a personal identification number associated with said financial instrument, further comprising a data segment including an encryption of said personal identification number associated with said financial instrument.

39. A computer data signal embodied in a transmission medium as recited in claim 35, wherein said second passcode further comprises digest of a personal identification number associated with said token.

40. A computer data signal embodied in a transmission medium as recited in claim 35, further comprising a data segment including an expiration date of said financial instrument.

41. A token for generating a passcode and a transaction count for use in a transaction verification system, said token comprising:
a. a keypad for entering numeric data related to a transaction to be verified;
b. a display for displaying information related to said transaction to be verified;
c. a processor operatively connected to said keypad and to said display; and
d. a memory operatively connected to said processor, wherein said memory is adapted to store a digest keyset and the transaction count, said processor is adapted with an encryption process using said digest keyset to generate a passcode comprising a digest of information related to said transaction entered on said keypad, and of said transaction count, said processor is adapted to increment said transaction count for each different transaction, said passcode comprises a digest of said transaction count, and said processor is adapted to output said passcode and said transaction count.

42. A token for generating a passcode and a transaction count for use in a transaction verification system as recited in claim 41, further comprising a key switch, that when activated, causes said processor to commence a new transaction by providing for an input of new information related to said transaction.

43. A token for generating a passcode and a transaction count for use in a transaction verification system as recited in claim 41, further comprising a key switch, that when activated, causes said processor to increment said transaction count, and causes said processor to generate and display said passcode from said information related to said transaction.

44. A token for generating a passcode and a transaction count for use in a transaction verification system as recited in claim 41, wherein said financial instrument comprises either a credit card or a debit card.

45. A token for generating a passcode and a transaction count for use in a transaction verification system as recited in claim 44, further comprising a magnetic stripe card reader for reading said identification number of said credit card or debit card from said credit card or debit card, wherein said magnetic stripe card reader is operatively connected to said processor.

46. A token for generating a passcode and a transaction count for use in a transaction verification system as recited in claim 41, wherein said information related to said transaction comprises an identification number of a financial instrument, and a transaction amount of said transaction.

47. A token for generating a passcode and a transaction count for use in a transaction verification system as recited in claim 41, wherein said information related to said transaction further comprises a personal identification number of said financial instrument.

48. A token for generating a passcode and a transaction count for use in a transaction verification system as recited in claim 41, wherein said passcode further comprises a digest of a personal identification number associated with the token.

49. A token for generating a passcode and a transaction count for use in a transaction verification system as recited in claim 41, wherein said digest keyset comprises a triple Data Encryption Standard (3-DES) digest keyset, and said encryption process comprises a 3-DES encryption of said transaction count as an initial vector for a 3-DES encryption process using said 3-DES digest keyset and using a cyclic block chaining (CBC) mode to generate a manipulation detection code (MDC) from information being digested.

50. A token for generating a passcode and a transaction count for use in a transaction verification system as recited in claim 41, wherein said processor is adapted to display at least one prompt or message on said display prior to reading said information related to said transaction.

51. A token for generating a passcode and a transaction count for use in a transaction verification system as recited in claim 41, wherein said processor is adapted to output an identification number associated with the token.

52. A token for generating a passcode and a transaction count for use in a transaction verification system as recited in claim 41, wherein said processor is adapted to output said passcode and said transaction count on said display.

53. A token for generating a passcode and a transaction count for use in a transaction verification system as recited in claim 41, wherein said processor is adapted with a communications interface to output said passcode and said transaction count via a communication interface to a computer system of a merchant.

54. A token for generating a passcode and a transaction count for use in a transaction verification system as recited in claim 53, wherein said communications interface comprises a wireless communications interface.

55. A token for generating a passcode and a transaction count for use in a transaction verification system as recited in claim 53, wherein said communications interface incorporates a carrier wave of either radio frequency, optical infrared, or acoustic wave energy.

56. A token for generating a passcode and a transaction count for use in a transaction verification system as recited in claim 55, wherein said acoustic wave energy incorporates dual tone multiple frequency modulation.
